(19) United States
(12) Patent Application Publication
(10) Pub. No.: US 2022/0294111 A1
(43) Pub. Date: Sep. 15, 2022

(54) Steerable High-Gain Wide-Angle Lens For Imaging Applications

(71) Applicant: Lassen Peak, Inc., North Bend, WA (US)

(72) Inventors: Behzad Yektakhah, Ann Arbor, MI (US); Ehsan Afshari, Ann Arbor, MI (US)

(21) Appl. No.: 17/666,389

(22) Filed: Feb. 7, 2022

Related U.S. Application Data
(60) Provisional application No. 63/161,323, filed on Mar. 15, 2021.

(51) Int. Cl. H01Q 3/14; H01Q 15/02; H01Q 19/06

(52) U.S. Cl. CPC H01Q 3/14; H01Q 15/02; H01Q 19/062

(57) ABSTRACT

An apparatus includes a lens with substantially flat first surface and a substantially tiered second surface opposite the substantially flat first surface, where the substantially tiered second surface has at least a central tier and a second tier, the central tier and the second tier each having a different thickness from the other tier, and where the thickness of each tier as measured orthogonally from the substantially flat first surface is chosen to provide a delay for the signal passing through the lens to approximate the characteristics of a Luneburg type lens as a radar beam is swept across the substantially first surface.

### CROSS-REFERENCE TO RELATED APPLICATIONS

This application claims priority to U.S. Provisional Patent Application No. 63/161,323, filed on Mar. 15, 2021, and titled Steerable High-Gain Wide-Angle Lens For Imaging Applications, the contents of which are hereby incorporated by reference in their entirety.

### BACKGROUND

Small size (compared to wavelength) radar antenna arrays output a relatively wide beam, providing for low-resolution scanning in imaging applications. Steering the beam through a wide angle can further widen the beam, thus making the scanner less effective, in terms of resolution, than it otherwise could be. To enhance spatial resolution and increase range of the radar system, a lens can be employed in conjunction with the antenna array. Ideally, in this function, the lens will narrow the beam and maintain the beam width over a large range of scan angle.

Among different known designs for lens, Luneburg lenses are capable of beam steering by changing the position/phase center of the antenna while maintaining the lens's focus. Unfortunately, a Luneburg lens is typically spherical with a continuously changing refractive index. These characteristics make the typical Luneburg Lens both difficult and expensive to manufacture, and difficult to employ in conjunction with a planar antenna array created by one or more microchips.

FIG. 1 illustrates the original design for a Luneburg lens. It is a lens with spherical shape whose material's refractive index (which equals the square root of the dielectric constant) varies radially from \sqrt{2} at the center of the sphere to 1 at the surface of the sphere. A Luneburg lens has two focal points, with one on the surface of the lens where a beam first impacts the lens (regardless of where on the surface the beam impacts, and the other at the infinity on the opposite side of the lens. If an antenna 102 is placed at any location of the lens surface, the beam 103 will be focused on the other side of the lens with a focal length at the infinity, providing a narrow beam and high spatial resolution for imaging. Because of geometrical symmetry of the lens, by rotating the antenna relative to the lens, the narrow beam is also rotated. In practice, however, since if the antenna system is planar and fixed in a position, moving the antenna on the lens spherical surface to rotate the beam is not feasible.

Thus, a need exists for a Luneburg-type lens that is relatively flat, relatively inexpensive to manufacture, and is compatible with planar antenna arrays in applications that require beam steering.

### SUMMARY

Embodiments of the present invention involve non-spherical Luneburg-type lenses with at least one flat surface that allows for the lens to function with a scanning radar planar antenna array. In an embodiment, a lens is disclosed providing the focusing characteristics of a Luneburg lens that includes one substantially flat surface across its length, including discretized tiered regions with the lens thickness varying from maximum at a center of the lens to a minimum at the edge of the lens such the thickness of each tier as measured orthogonally from the substantially flat first surface is chosen to provide a delay for the signal passing through the lens to approximate the characteristics of a Luneburg type lens as a radar beam is swept across the substantially first surface.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram representing a prior-art embodiment of a Luneburg lens.

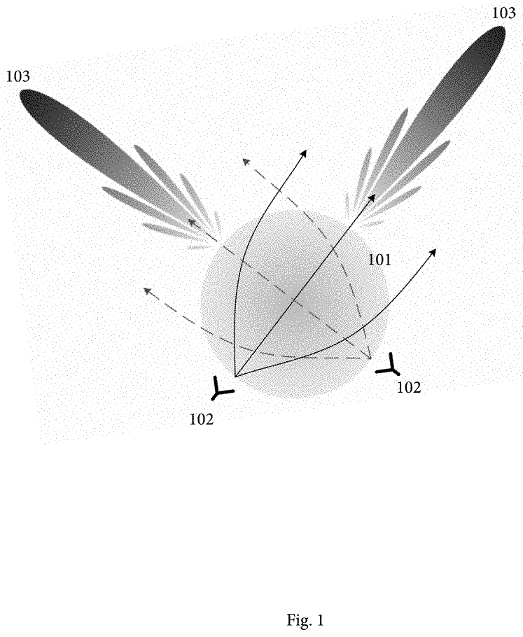

FIG. 2 is a cross-sectional diagram representing a prior art embodiment of a Luneburg-type lens with two substantially parallel flat surfaces, and with a continuously varying refractive index.

FIG. 3 is a cross-sectional diagram representing a Luneburg-type lens with two substantially parallel flat surfaces, which includes parameters for modeling the refractive index, according to an embodiment of the invention.

FIG. 4 is a cross-sectional diagram representing a Luneburg-type lens with two substantially parallel flat surfaces and that comprises multiple discrete regions each with a substantially constant refractive index across the region according to an embodiment of the invention.

FIG. 5 is a perspective view of a disk-shaped discretized Luneburg-type lens using different materials, according to an embodiment.

FIG. 6 is a cross-sectional view of a Luneburg-type lens with one flat surface using the same materials, according to an embodiment.

FIG. 7 is a perspective view of a disk-shaped discretized Luneburg-type lens with one flat surface using the same materials, according to an embodiment.

FIG. 8 is a perspective view of a disk-shaped discretized Luneburg-type lens using a single material that has a changing structure, according to an embodiment.

FIG. 9 is a perspective view of a disk-shaped discretized Luneburg-type lens using a single material that has a changing structure, according to an embodiment.

FIG. 10 is a perspective diagram of a building block of a Luneburg-type lens, according to an embodiment.

### DETAILED DESCRIPTION

One or more of the systems and methods described herein describe a way of providing a system and method for noninvasive searches. As used in this specification, the singular forms “a” “an” and “the” include plural referents unless the context clearly dictates otherwise. Thus, for example, the term “a computer server” or “server” is intended to mean a single computer server or a combination of computer servers. Likewise, “a processor,” or any other computer-related component recited, is intended to mean one or more of that component, or a combination thereof.

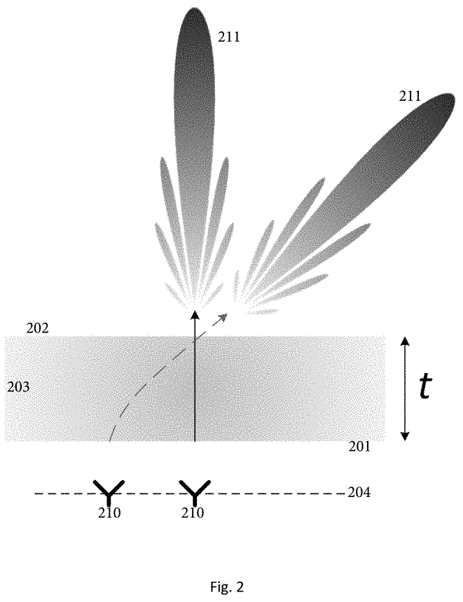

FIG. 2 is a cross-sectional diagram representing a prior art embodiment of a Luneburg-type lens with two substantially parallel flat surfaces 201 and 202 at bottom and top, respectively. The two flat surfaces 201 and 202 are separated by a distance t, the thickness of lens 203. In this embodiment, lens 203 has a refractive index that decreases continuously from the center of the lens (maximum value) to the edge (minimum value) as one travels along the lens parallel to the flat surfaces. The variation of the refractive index determines the location of the lens's focal points, which is located on an imaginary plane 204 parallel to the lens surface and at a distance l(0) (not shown) from the lens. One skilled in the art will appreciate that in a flat Luneburg lens, the focal points need not be placed on the surface of the lens. The focal points can be placed on a plane at a certain distance from the lens surface (with the other focal points are still at the infinity on the other side on the lens), allowing for flexibility in antenna array placement.

Each focal point on one side of the lens has a corresponding conjugate focal point at infinity. In other words, if an antenna 210 is placed on a first focal point of the lens (close to the lens surface 201), its beam 211 emerges narrower on the other side of the lens. By moving antenna 210 in a direction parallel to flat bottom surface 201 and on the plane of focal points 204 (for example, from the center of the lens to a point to the left of center, as shown in FIG. 2), the direction of beam is rotated while its width and directivity remains substantially constant.

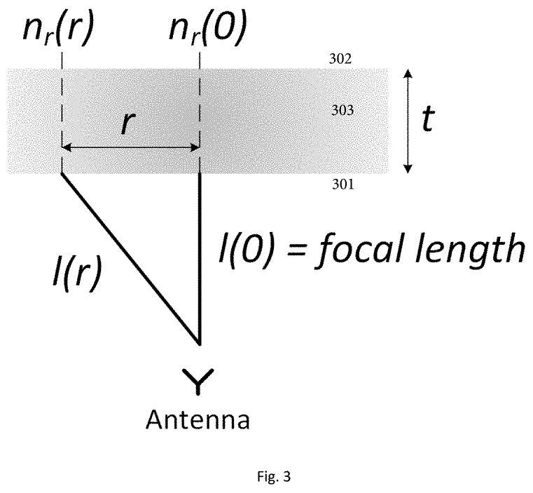

FIG. 3 is a cross-sectional diagram representing a Luneburg-type lens 303 with two substantially parallel flat surfaces (bottom surface 301 and top surface 302), that includes parameters for modeling the refractive index, according to an embodiment of the invention. This diagram portrays substantially the same lens as displayed in FIG. 2, but provides the parameters used to model the relationship between the focal length, lens thickness, and refractive index as a function of the radial distance from the center of the lens. In this model, the refractive index of the material n(r) is shown as a function of the various parameters as follows:

$$n ( r ) = \frac{tn ( 0 ) + l ( 0 ) - l ( r )}{t}$$

where t is the lens thickness (in FIG. 3), r is the radial distance from the center, n(r) is the refractive index of the material at the distance of r from the center. l(0) is the focal length and l(r) is the distance between the focal point (which acts as a phase center) and the nearest pointon the lens surface to the focal point at the radial distance r from the center. By setting (i) the maximum refractive index at center (n(0)), (ii) the focal length, and (iii) the lens thickness, the profile of refractive index n(r) can be derived using this equation.

According to this equation, one can determine the various design constraints as follows:
r can be increased up to the point that results in n(r)=1.
Maximizing radius of the lens is preferred since it results is a larger gain and narrower beam. To increase the radius of lens:
   maximum refractive index must be increased and/or;
   focal length must be increased and/or;
   lens thickness must be increased.
Increasing the maximum refractive index increases the reflection from the lens and saturates the receivers; thus, a material with lower refractive index that reduces or minimizes these problems is desired. As an example, if the material selected for the lens is Teflon, with a refractive index of 1.45 and with very low losses at high frequencies, then analyses show less than 12 dB of reflection coefficient from the lens.
Increasing lens thickness increases transmission loss inside the lens and reduces the gain. In some cases, a thick lens may not be practical for fabrication.

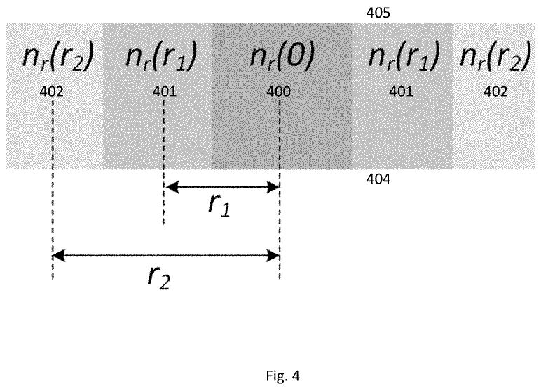

In an embodiment, the lens has discrete regions, and each region has a fixed refractive index. The refractive indices of the regions vary from the highest value at the center to the lowest value at the edges. FIG. 4 is a cross-sectional diagram representing a Luneburg-type lens with two substantially parallel flat surfaces (bottom surface 404 and top surface 405) and that comprises multiple discrete regions that include center region 400, and regions 401 and 402 (repeating symmetrically on each side of center region 400). Each region has a substantially constant refractive index across the region, and each region has a smaller refractive index, as one proceeds outward from center region 400, according to an embodiment of the invention. While the lens shown in the figure has two regions beyond center region 400, in other embodiments, the lens can have three or more regions beyond center region 400, depending on the size of lens desired.

As shown in the figure, the distance r₁ and r₂ are measured from the center of the lens to the center of region 1 (with refractive index of n(r₁)) and region 2 (with refractive index of n(r₂)), respectively. To generalize, the r is the distance from the center of the lens to the center of a region. The variable r is used in the equation above to find the refractive index of that region.

In embodiments, different refractive indices can be achieved by (1) using different material types; (2) changing the density of the material; and (3) using periodic structures with dimensions less than the wavelength. One skilled in the art will understand that, while we are using the center as a reference point, the maximum refractive index (or maximum thickness) can be moved to a spot other than the center. In this case the lens still works but its response (beam direction) as a function of the location of antenna is not symmetric.

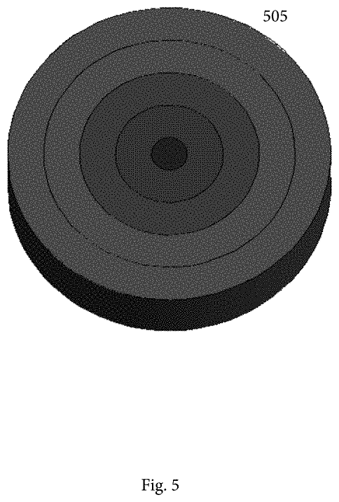

FIG. 5 is a perspective view of a disk-shaped discretized Luneburg-type lens using different materials, according to an embodiment. In this embodiment, each concentric circle uses a different material from the previous region such that the refractive index is highest in the center-circle region and decreases by step as measured radially outward from the center of the disk. As discussed with regard to FIG. 4, the lens has two substantially parallel flat surfaces, a top surface 505 and a bottom surface (not shown in FIG. 5), and that comprises multiple discrete regions each with a substantially constant refractive index across the region, according to an embodiment of the invention. The distance, r, is defined from the center of the lens to the center of each region and used in the equation above to determine the region refractive index.

For the purposes of the present application, the term “different material” means a realization that results in a different refractive index for the material of each region, which can mean a different material type (different element or compound), a material with a different density, a material with a different doping, or a material with a different structure.

In an embodiment, the refractive index is defined for each substantially concentric circular region by changing the density of the material used in each circle, rather than by changing the type of material. Similar to the previous embodiment, the end result is that the lens has discrete regions of different effective refractive indices.

In an embodiment, to create discrete regions, one can vary both the materials and the density of each region.

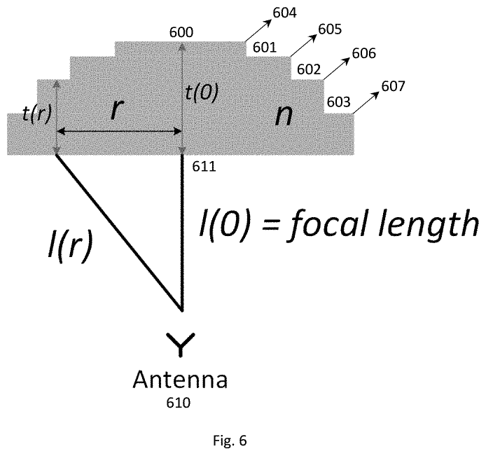

FIG. 6 is a cross-sectional view of a Luneburg-type lens using the same material, according to an embodiment. In an embodiment, antenna 610 emits radiation that impinges on flat bottom surface 611 of the lens. The lens includes a number of tiered regions with surfaces 601, 602, and 603 that vary in thickness from the surface of center region 600 (the thickest region of the lens as measured from the flat bottom surface 611) to the edge region 603 (the thinnest region of the lens as measured from flat bottom surface 611). FIG. 6 shows regions 600-603, but one skilled in the art will understand that the lens can include any number of regions of discrete thickness, where each region can be denoted by the subscript “i,” and wherein the distance from a reference point on the center region to a reference point on each tier can be measured as discrete distances r₁, r₂, . . . , and rᵢ, which are the effective distances from the reference point on each tier to the reference point on the center region. In an embodiment, each tier “i” has a surface substantially parallel to the plane of flat bottom surface 611.

The lens has a flat bottom surface 611 where radiation from antenna 610 impinges and then transits through the lens according to generally known optical principles and produces a narrower beam compared to the antenna output at the top of the lens. By moving antenna 610 back and forth, the narrow beam is directed to different directions while its width remains constant.

The relation among the focal length, the region/tier thickness, and the refractive index as a function of radial distance from the center (r) is as follows:

$$t ( {r}_{i} ) = \frac{l ( 0 ) - l ( {r}_{i} ) - t ( 0 ) + t ( 0 ) n}{n - 1}$$

where, with reference to FIG. 6, t is the lens thickness, n is the refractive index of the material, and the distance rᵢ is defined from a reference point on the center surface of the lens to a reference point on each tier and used in the equation above to determine the region thickness. In an embodiment, the reference point on the center surface can be the center of the center surface, and the reference point on the surface of the “i^{th}” tier can be the center of the “i^{th}” surface as measured from the outer edge of the previous tier to the outer edge of the “i^{th}” tier. In other words, each tier is defined has having an inner edge (as measured radially from the center of the device) and an outer edge. Thus, in an embodiment, the reference point for the “i^{th}” tier can be found at a point midway between the inner edge and the outer edge of that tier. As shown in FIG. 6, the center portion of the lens has an edge 604, the first tier has an edge 605, the second tier has an edge 606, and the third tier has edge 607, and thus the midpoint of a surface is measured as midway between an edge of the surface, and the edge of the previous surface closer to center 600. l(0) is the focal length and l(rᵢ) is the distance between the focal point and the nearest point on the lens surface to the focal point at the radial distance of rᵢ from the center. By setting the maximum thickness at center (t(0)), focal length, and n, the thickness profile of lens, t(rᵢ), is derived using this equation. The design constraints are similar to the first design.

In an embodiment, the lens structure can be discretized such that, within each region, the thickness is kept substantially constant, as shown in FIG. 6.

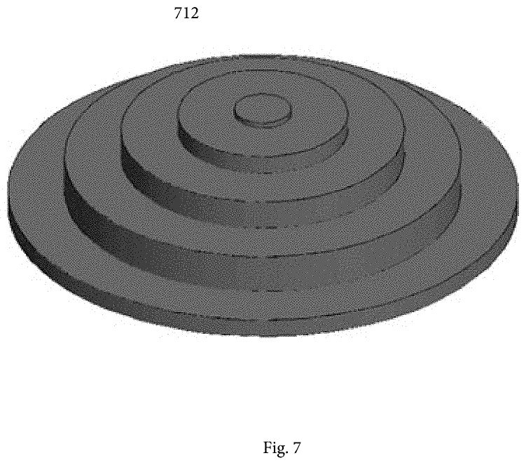

FIG. 7 is a perspective view of a disk-shaped discretized Luneburg-type lens using the same material with varying thickness, according to an embodiment. In an embodiment, the lens is realized using Teflon with the thickness that varies from approximately 7 mm to approximately 1 mm. As in FIG. 6, the lens has a flat bottom surface (not shown) where radiation from an antenna impinges for transmission through the lens. As the radiation is swept back and forth across the flat bottom surface, it transits through the lens, and it is emitted from top surface 712 with substantially the same beamwidth but directed to different directions.

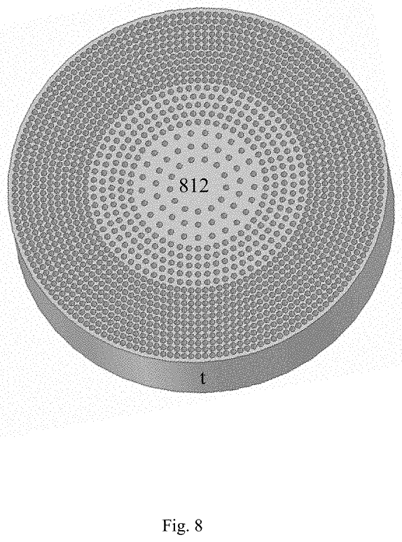

FIG. 8 is a perspective view of a disk-shaped discretized Luneburg-type lens using a single material with a changing structure, according to an embodiment. In this embodiment, the lens is substantially disc shaped with a top surface 812 that is substantially parallel to a bottom surface (not shown), and a thickness t separating top surface 812 from the bottom surface. As in the previous embodiments, as the radiation (antenna location) is swept back and forth across the substantially flat bottom surface, it travels through the lens, and it is emitted from top surface 812 with substantially the same beam width and shape but directed to different directions. In an embodiment, the lens is Teflon with a periodic array of holes drilled into top surface 812 and all the way through the bottom surface. The lens displays an array of holes with increasing surface density as measured radially outward from the center of the disk. The increasing density of the holes provides for a variation in the refractive index of the lens seen by a wave passing through the lens (effective refractive index) such that the refractive index is maximum at the center of the disk and decreases radially across the lens as the surface density of holes increases. The effective refractive index is minimum at the disk's edge, where the number of holes is at a maximum density. In an embodiment, the holes are of uniform diameter smaller than the wavelength of the radiation. The number of holes per unit of area determines the effective refractive index.

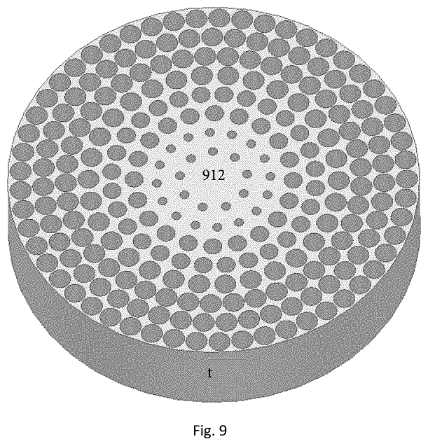

In an embodiment, as shown in FIG. 9, the holes are of varying diameter across the lens, resulting in a varying surface density and effective refractive index. For the purposes of the present invention, the phrase surface density, or surface density of holes, means the number of holes per given area as measured on the surface of the lens.

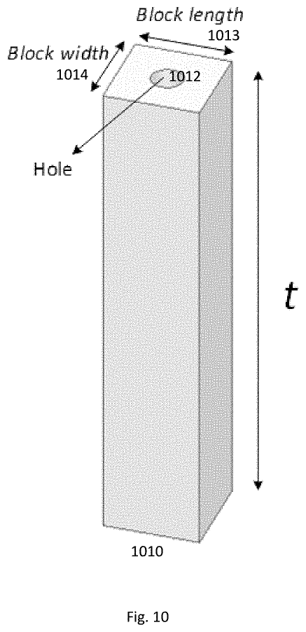

FIG. 10 is a perspective diagram of a building block of the Luneburg-type lens shown in FIGS. 8 and 9. The block length 1013 and width 1014 can vary (as in FIG. 8) or remain constant (as in FIG. 9). In an embodiment, the hole or void 1012 is drilled at the center of the block from the top surface all the way down the height (or thickness) t to and through the bottom surface. The hole 1012 diameter can be either constant (FIG. 8) or varying (FIG. 9). The holes are parallel to the thickness of the lens, according to an embodiment. The ratio of the hole cross section area to the block cross section area determines the effective refractive index of the block, where a higher ratio results in a lower refractive index. In an embodiment shown in FIG. 8, building blocks with different block size but the same hole diameter are arrayed across the lens to vary the effective refractive index. One skilled in the art will understand that the lens shown in FIG. 8 is a solid piece of material and the block displayed in FIG. 10 is not a piece that is distinct from the rest of the lens.

In an embodiment shown in FIG. 9, the block size 1013 and 1014 remains constant but the hole diameter varies to provide the desired effective refractive index. One skilled in the art will understand that the lens in FIG. 9 is a solid piece of material made up of multiple blocks shown in FIG. 10.

To derive the effective refractive index of a block in FIG. 10, an infinite array of the blocks with the same block size and hole diameter is analyzed using the plane wave excitation and Floquet theorem. Comparing the phase shift in the plane wave passing through the periodic structure to that of a homogeneous medium with the same thickness, the effective refractive index is derived. As an example, assuming Teflon as the material of the block, and using a hole diameter of 0.4 mm, the effective refractive index versus block size is shown in Diagram 1, below. The thickness for the block (which is also the lens thickness) is assumed to be 6 mm.

While certain embodiments have been shown and described above, various changes in form and details may be made. For example, some features of embodiments that have been described in relation to a particular embodiment or process can be useful in other embodiments. Some embodiments that have been described in relation to a software implementation can be implemented as digital or analog hardware. Furthermore, it should be understood that the systems and methods described herein can include various combinations and/or sub-combinations of the components and/or features of the different embodiments described. For example, types of verified information described in relation to certain services can be applicable in other contexts. Thus, features described with reference to one or more embodiments can be combined with other embodiments described herein.

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiment are illustrated in the figures and described above, the present disclosure should in no way be limited to the exemplary implementations and techniques illustrated in the drawings and described herein.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

We claim:

1. An apparatus comprising:
a first region of a material with a first substantially flat bottom and having first thickness measured from the first substantially flat bottom;
a second region of the material with a second substantially flat bottom, the second region surrounding, and in contact with, the first region, the second region having a second thickness measured from the second substantially flat bottom;
a third region of the material with a third substantially flat bottom, the third region surrounding, and in contact with, the second region, the third region having a third thickness as measured from the third substantially flat bottom;
wherein the first substantially flat surface, the second substantially flat surface, and the third substantially flat surface are positioned to be substantially coplanar to form a substantially flat lens bottom surface
wherein the apparatus acts as a lens with the first thickness, the second thickness, and the third thickness being chosen to provide a focused beam that is steered by changing the phase center of the antenna while maintaining focus as a radar beam is swept across the lens bottom surface.

2. The apparatus of claim 1, wherein the material is a single block of material.

3. The apparatus of claim 2, wherein the apparatus has a defined center, and wherein first thickness, the second thickness, and the third thickness differ from one another in discrete steps as a function of distance from the defined center.

4. The apparatus of claim 3, wherein the apparatus is substantially radially symmetric from the center of the first region.

5. The apparatus of claim 4, further comprising an antenna.

6. An apparatus comprising:
a lens with substantially flat first surface and a substantially tiered second surface opposite the substantially flat first surface, the substantially tiered second surface comprising at least a central tier and a first tier, the central tier and the first tier each having a different thickness from the other tier, and
wherein the thickness of each tier as measured orthogonally from the substantially flat first surface is chosen to provide a delay for the signal passing through the lens to approximate the characteristics of a Luneburg type lens as a radar beam is swept across the substantially first surface.

7. The apparatus of claim 6, wherein the tiers are all formed from a single material.

8. The apparatus of claim 6, wherein the substantially flat first surface includes a center point, and wherein the thickness of the lens at the first tier is greater than the thickness of the lens at any other tier, and wherein the lens is substantially radially symmetric as measured from the center point.

9. The apparatus of claim 8, wherein the thickness of each tier is substantially approximated by the function
$$t ( {r}_{i} ) = \frac{l ( 0 ) - l ( {r}_{i} ) - t ( 0 ) + t ( 0 ) n}{n - 1}$$
where the lens substantially consists of a material with a refractive index of n, and where t(rᵢ) is the thickness of the apparatus as measured perpendicular to the substantially flat surface, l(0) is the focal length of the lens at its thickest point and from the lens flat surface, l(rᵢ) is the distance between the focal point and the nearest point on the lens flat surface to the focal point at the radial distance of rᵢ from the center point to a reference point on the second surface.

10. The apparatus of claim 9, wherein lens is substantially circular in a plane that contains the substantially flat bottom surface.

11. The apparatus of claim 10, further comprising an antenna placed proximate to the flat surface at a distance from the flat surface that is one focal length from the center of the lens.

12. An apparatus comprising:
a material that is formed in a substantially circular shape in a first plane, the substantially circular shape having a first diameter and a center;
a plurality of substantially circular tiers etched into the material above the first plane, where each tier thickness selected such that the apparatus acts as a lens to provide beam steering by changing the phase center of the antenna while maintaining focus as a radar beam is swept across the lens bottom surface.

13. The apparatus of claim 12, wherein each tier includes a substantially flat surface substantially parallel to the first plane, and wherein the thickness of each tier is substantially approximated by the function
$$t ( {r}_{i} ) = \frac{l ( 0 ) - l ( {r}_{i} ) - t ( 0 ) + t ( 0 ) n}{n - 1}$$
where the lens substantially consists of a material with a refractive index of n, and where t(rᵢ) is the thickness of the apparatus as measured perpendicular to the substantially flat surface, l(0) is the focal length of the lens at its thickest point, l(rᵢ) is the distance between the focal point and the nearest point on the lens surface to the focal point at radial distance of rᵢ from the center, where rᵢ is a radial distance from the center to a reference point on the substantially flat surface of each tier.

14. The apparatus of claim 13, wherein each surface has an edge, and wherein the reference point of each surface is midway between the edge of each surface and the edge of an adjacent surface closer to the center.

15. The apparatus of claim 13, further comprising an antenna placed proximate to the substantially circular shape at a distance from the substantially circular shape that is one focal length from the center.
